(19) United States
(12) Patent Application Publication
(10) Pub. No.: US 2009/0059922 A1
(43) Pub. Date: Mar. 5, 2009

(54) Systems and Methods for Multicast Communication

(76) Inventors: Barry Appelman, New York, NY (US); Andrew Lee Wick, McLean, VA (US); Alan H. Keister, Oakton, VA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/202,122

(22) Filed: Aug. 29, 2008

Related U.S. Application Data
(60) Provisional application No. 60/969,087, filed on Aug. 30, 2007.

(51) Int. Cl. H04L 12/56

(52) U.S. Cl. 370/390

(57) ABSTRACT

Embodiments of multicast messaging systems and methods are disclosed for facilitating the multicasting of messages and/or other content to a group of users such that users may send messages to a group. One embodiment includes a method of transmitting multicast messages, including receiving a first multicast message and an indication of a first message group from a first sending user, identifying a first set of recipients related to the first message group, and transmitting the first message to the identified recipients. Another embodiment includes a computer system configured to receive a multicast message designating a group and then to communicate the multicast message to intended recipients.

### RELATED APPLICATIONS

This application claims the benefit under 35 U.S.C. § 119(e) of U.S. provisional application 60/969,087, filed Aug. 30, 2007 and entitled “Systems And Methods For Instant Message Multicasting,” which is hereby incorporated by reference herein in its entirety.

### BACKGROUND

1. Field of the Invention

The invention relates to the field of communication and social networking and to systems and methods for sending messages to groups of recipients.

2. Description of the Related Art

The ability to remotely communicate with others has been pursued and expanded significantly over time. A variety of systems and methods are known to facilitate remote communication among individual users. For example, telephone systems are widely used to communicate voice signals, image files, and/or text messages between individuals. Network connected computer systems can also be used to communicate voice, audio, graphics, text, and other data/program files among users of the systems.

For example, network-connected computers and devices can implement electronic mail (e-mail) protocols to allow a user to send a newly created or previously existing message to one or more other users. An e-mail message can include text alone as well as various files, such as image data, audio data, and/or links to online resources. Network-connected computers and devices can also implement instant messaging systems to allow two users exchange text-based messages. Instant messaging systems offer the advantage of very rapid exchange of messages between the two users. In some implementations, instant messaging systems include the ability to notify one user that the other user is drafting a message to him or her so that the first user knows to expect a message shortly.

### SUMMARY OF THE DISCLOSURE

While existing communication systems offer a wide variety of communication options, embodiments of the invention are based at least in part on a recognition of certain limitations in existing systems and methods of communication. Some embodiments are based on an understanding that there is an unsatisfied need for systems and methods to facilitate the exchange of communication among a plurality of users in a convenient rapid manner. There is also an unsatisfied need for the ability to easily define and modify communication groups such that desired information is shared within the group, but not disseminated outside the group. There is also an unsatisfied need for the ability to discriminate among potential recipients of a message such that a user can expect that a sent message will be timely received by actual recipients who can consider the sent message and then respond as needed/desired in a timely manner. There is also an unsatisfied need to support dynamically modifiable user groups so that individual users can receive more relevant message content, particularly as users' interests change and/or as new members join the communication system.

Some embodiments of the disclosure address one or more of the needs discussed above by providing a system for multicasting messages to groups of users. The received multicast messages can then be displayed to a group of recipient users. In one embodiment, the received multicast messages are displayed in a window of a user interface. In some embodiments, users can create and modify user groups or users can be automatically added to one or more user groups.

In one embodiment, a method of transmitting multicast messages is provided. The method may include: receiving a first multicast instant message from a first sending user, the first multicast instant message indicating a first group; identifying a first set of recipients related to the first group; and transmitting the first multicast instant message to the first set of recipients.

In another embodiment, a multicast messaging system is provided. The multicast messaging system may include a computer system having a processor that supports operation of a software application; a data storage module, including a plurality of group data, in communication with the computer system; and a multicast message module configured to: receive a first multicast message from a first sending user, the first multicast message indicating a first multicast message group, identify a first set of recipients related to the first message group using the plurality of group data, and transmit the first message to the identified recipients; and wherein the computer system is capable of receiving a multicast message and communicating the multicast message to the multicast message module.

In a further embodiment, a computer readable storage media is provided. The computer readable storage media may include instructions to cause a first computer access data related to a plurality of multicast message groups; instructions to cause the first computer to receive a first multicast message from a first sending user, the first multicast message indicating a first of the multicast message group; instructions to cause the first computer to identify a first set of active recipients who are members of the first message group and are actively in communication with the first computer; and instructions to cause the first computer to transmit the first message to the first set of active recipients.

For purposes of describing embodiments of the invention, some aspects, advantages and novel features are described herein. Of course, it is to be understood that not necessarily all such aspects, advantages or features will be embodied in any particular embodiment of the invention. In addition, a feature of one embodiment may be included as a feature in a different embodiment.

### BRIEF DESCRIPTION OF THE DRAWINGS

FIG. 1 illustrates an embodiment of an exemplary screen shot of a display of a messaging multicast system.

FIG. 2A is a schematic illustration of an embodiment of group definitions in a multicasting communication system.

FIG. 2B is a schematic illustration of another embodiment of group definitions in a multicasting communication system.

FIG. 3A illustrates embodiments of multicast messaging group definitions in a multicast communication system.

FIG. 3B illustrates embodiments of user options in a multicast communication system.

FIG. 3C illustrates one embodiment of an example user interface that allows a user to edit his group options.

FIG. 4A illustrates an embodiment of an exemplary screen shot of a display of a messaging multicast system.

FIG. 4B illustrates another embodiment of an exemplary screen shot of a display of a messaging multicast system.

FIG. 5 is a flow chart of an embodiment of using a messaging multicast system.

FIG. 6A is a flow chart of an embodiment of a multicast communication system.

FIG. 6B is a flow chart of an embodiment of a multicast communication system.

FIG. 7 is a high-level block diagram of an embodiment of a multicast communication system.

### DETAILED DESCRIPTION OF EMBODIMENTS

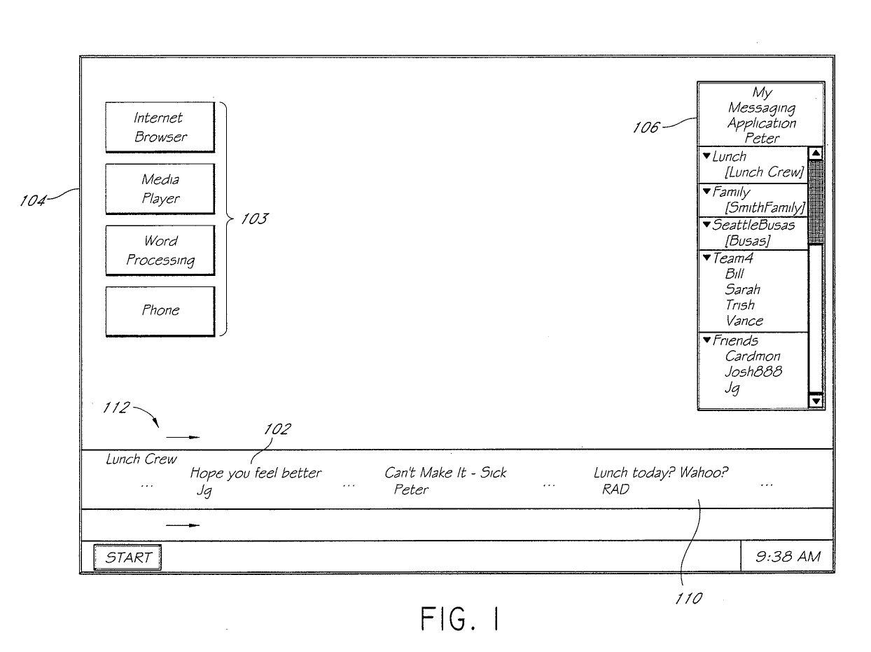

FIG. 1 illustrates an example display 104 of an embodiment of a multicast messaging or communication system 100 configured to facilitate the multicasting of messages and/or other content 102 to a group of users where a user sends an instant message to the group and each of the users in the group can then display/play the instant message 102 on his or her system. The example display 104 shows a desktop for user “RAD,” which includes application icons 103 as well as an instant messaging application 106. The instant messaging application 106 lists the user's messaging buddies which includes individual users, such as Bill and Caedmon, as well as groups, such as the “Smith Family” and “Lunch Crew.”

The example display 104 also includes a scrolling window 112 which includes multicast messages 102, 110 received from the Lunch Crew group. The messages 102, 110 include the text of the message (for example, “Lunch today? Wahoo?” and “Can't make it—sick”) along with a name, screen name, nickname, or other personal descriptor of the sender (for example, RAD and Peter). As seen in the scrolling window 112, “jg,” “Peter,” and “RAD” are all members of the Lunch Crew group.

As new messages are received, the messages are displayed in the window 112 from left to right in a scrolling or tickertape manner without the distraction or interruption of a pop-up window. In other embodiments, the scrolling window 112 may include messages from more than one group and/or the messages could be presented in a different manner, such as right to left, up to down, or down to up. In addition, a different type of window, such as a pop-up window, could be used or a different type of user interface may be used.

While the exemplary messages include text, other content may be included, such as, for example, voice messages, audio files, image files, video files, applets, other executable files, and/or combinations of the above. However, in some embodiments, text messages are the preferred content to facilitate more rapid communication of the messages. In addition, icons, colors, fonts, sounds, textures, backgrounds, bordering, and/or other types of designations can indicate the sender and/or group for a message.

### I. Groups

A. Sample Groups

A group may include two or more members such that when a message is sent to a group, the message is sent to all of the members in the group, including the sending user. In other embodiments, the message is not sent to or displayed by the sending user. The group may appear to a user as another user and have its own name, web page, profile, and/or screen name. In addition, the group may appear as a “buddy” in the buddy list of the group's members.

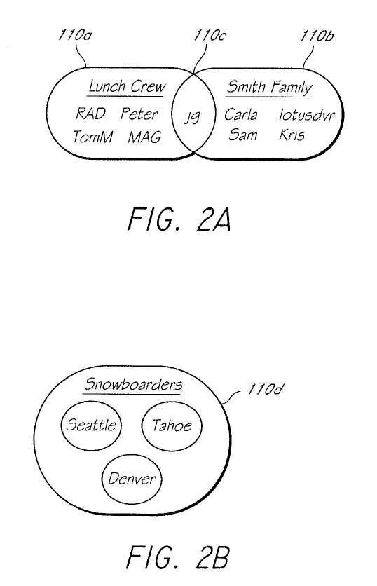

FIG. 2A illustrates embodiments of two example groups from FIG. 1 and the logical relationships between members of those groups. As noted above, the Lunch Crew group 100a includes RAD, Peter, jg, TomM, and MAG, whereas the Smith Family group 110b includes Carla, lotusdvr, Sam, Kris, and jg. User jg is part of both the Lunch Crew group and the Smith Family group, and he is included in the intersection of the Lunch Crew and Smith Family groups 110c.

The multicasting messaging system 100 allows users to define their own groups using a variety of different categories. For example, a group may be based on geographical location (for example, UK, Altus, Irvine, WeHo, and so forth), users' interests (for example, motorcycle riding, snowboarding, gourmet cooking, tennis, Alzheimer's support, scrapbooking, history, Mediterranean cooking, and so forth), relationships (for example, co-workers, family, alumni, and so forth), as well as any other type of category. In addition, a group may be based on any combination of categories (for example, owners of a particular brand motorcycle who also live near Altus, Okla., or people that love history as it relates to classical music, and so forth). In addition, a group may be subdivided into multiple subcategories as shown in FIG. 2B, where a group of snowboarding enthusiasts is broken down into sub-groups of snowboarding enthusiasts who live in a particular areas, Seattle Tahoe, and Denver 110d. Users can join one or more groups. For example, a user can join a group that includes her family members, a group of her co-workers, as well as a group that shares her interest in golfing.

In some embodiments, the groups may have the same name. For example, there may be a “Lunch Crew” group that is created by user RAD as well as a “Lunch Crew” group that is created by user Carla. The system may restrict a user from joining two groups with the same name, or the system may allow a user to join two or more groups with the same name. In addition, the system may allow users to differentiate their groups by using different icons, colors, sounds, fonts, and so forth or by creating a nickname for the groups that is different from the actual name, such as, “Lunch Crew—just the girls” and “Lunch Crew-co-workers.” In other embodiments, the system may require that each group has a unique name.

In some embodiments, a user may use a different username for different groups. For example, “RAD” and “lotusdvr” may actually be the same user. Thus, a user may have a single username that is associated with one or more different groups or can have a different usernames for one or more of a plurality of different groups.

B. Joining a Group

In one embodiment, there are three primary ways to join a group. First, a user may create a new group by including himself as one of the members and then invite other users to join the group. For example, a user may send out an invitation to other users and/or groups to join a group via e-mail or an instant message. The invitation may include a link to a webpage for the group so that am invited user can learn more about the group before making a decision. The invited user may then choose to accept or decline the invitation. The inviting user can then check his buddy list or the webpage of the group to see if his invitees accepted the invitations.

Second, a user may ask to be added as a member to one or more groups. For example, a user may review web pages for various groups, find a group she wishes to join, and then sends a request to the group asking to be added as a member. Some groups may allow automatic membership to users who want to join, whereas other groups may review the requests and make a decision as to whether to let the user join. For example, a group may have specific criteria that it requires for its members. In addition, a user may join a group by accepting an invitation to join the group.

Third, a user may be automatically added to a group based on predetermined criteria such as, for example, when a new user joins the system or when an existing user's information changes. Thus, a user may indicate one or more personal interests, their geographic location, their family, work position, and so forth, and the user may be automatically added to the appropriate group(s). For example, a newly married person may be dynamically added to the respective family group of his new spouse, or after a new worker is hired into the human resources department of a company, the new worker may be dynamically added to the company's human resources group.

C. Group Options

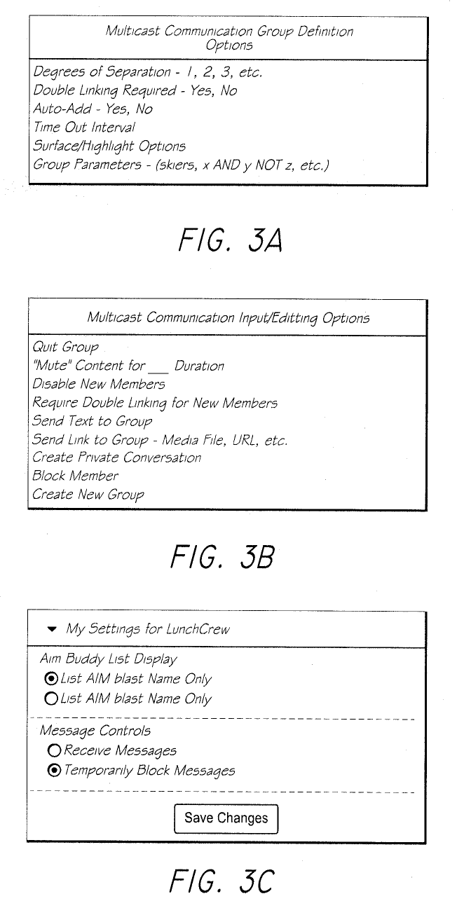

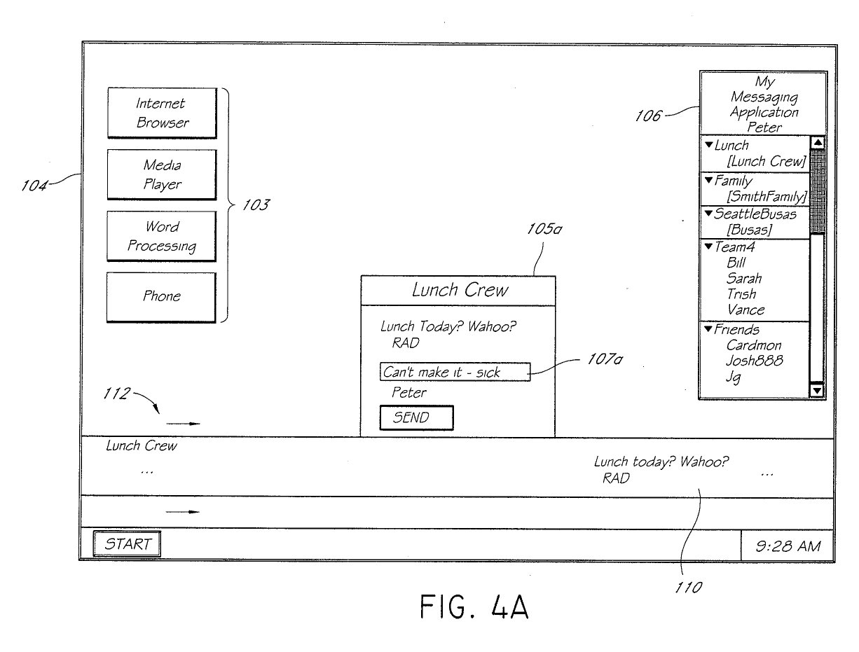

FIG. 3A illustrates embodiments of example multicast messaging group definitions that can be used to define a group. For example, a group can be defined on degrees of separation required for membership in the group. For example, one degree of separation would correspond to one person designating another person as his or her buddy. Two degrees of separation can correspond to a first user designating a second user as his or her buddy and the second user designating a third user as his or her buddy, such that the third user is also designated as a buddy of the first user via his or her connection to the second user.

Another option that may be used in a group definition is whether double linking is applied. For example, to become a member of a group, the group may require that other users of the group have designated him as his buddies and he has reflexively accepted the other users as his buddies. A further option may include whether a user is automatically added to a group. For example, all users satisfying the criteria for a group may be automatically added to the group without requiring any confirmation or input on his or her part. In other embodiments, joining a group may request some action or indication of acceptance by a user and/or the group.

An additional option is a time-out interval setting. For example, a group may delete a member from a group if a member is inactive, for example provides no input or comment, for a given period of time. This option can include a warning or notification to the member that his lack of activity is prompting his potential removal from the group. The member may be automatically deleted at a certain amount of inactivity or after a set amount of inactivity after a warning was sent.

A further option is to provide an indicator for the group to differentiate it from other groups. The indicator can include names or abbreviations, with a characteristic color, with a characteristic texture or background, with a characteristic bordering, with a characteristic font or font size, with a unique icon, and so forth.

An additional option is to include a set of parameters that are used to define a group. These one or more parameters can also be designated with Boolean operators. For example, a group can be defined based on a single interest, for example, a group of skiers. Another group may be defined based on the parameters of working AND female, but NOT mothers.

The multicast messaging system 100 may also allow a group to permit only one-way communication, such as, for example, to only allow group administrator's to send a message. This setting may be used for groups that are treated as notification groups or that are so large such that unrestricted communication may be too confusing to follow.

D. User Options

In addition, to the group settings, the system may also allow users to customize their settings for sending/receiving multicast messages. FIG. 3B illustrates a variety of options a user may set to control the user's interaction with a given messaging multicast group. A user may use the same options for all of her groups, or the user may set different options for different groups or sets of groups.

The following provides some example options that a user may set for her group(s). A user may elect to “quit” or leave the group. A user may “mute” the content of one or more groups for some given duration, thus allowing the user to temporarily stop receiving messages from the group without actually leaving the group. A user may create an “automatic response message” that is automatically sent when a message is sent to the group without the user's direct input. For example, a worker may provide an indication that she is on vacation, via a response message, a text tag, an image tag, and/or a unique coloration or pattern associated with her user name. A user may disable or inhibit adding new members to the group. A user may require double-linking between potential members for membership in the group. A user may choose to send text-based content to the group. A user may choose to send a link to a file or a file itself to the group. For example, a user may forward a media file, a URL, and so forth, to the membership of a given multicast messaging group. A user may indicate that he wants to establish a private link separate from remaining members of the group with another group member. A user may block, temporarily ignore, and/or deselect one or more other members. For example, a user may exclude an existing member of a group and/or block a given user from joining a group if the selected user has previously exhibited troublesome or offensive conduct. As another example, a worker may wish to suppress display of multicast messaging content from their co-workers while she is on vacation. A user may create a new group, which can include creating a subset of an existing group. A user may turn the messaging system sounds off.

FIG. 3C illustrates an example user interface that allows a user to edit his group options. The example interface includes options that allow the user to list names and members or name only, and to receive messages for a group or temporarily turn them on off.

It is recognized that a variety of group and user options may be provided in addition to or instead of the examples provided above. In addition, group options may also be user options and that user options may be group options.

### II. Creating and Sending a Message

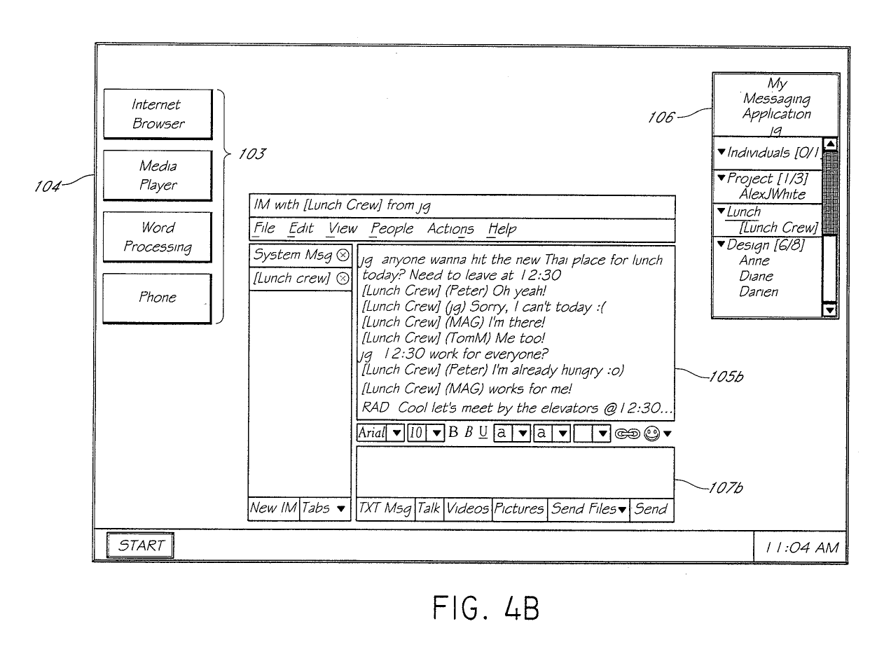

Continuing with the example in FIG. 1, FIG. 4A illustrates an example display 104 for the user Peter who is creating a message to send to the Lunch Crew group.

RAD sent a message stating “Lunch Today? Wahoo?” 110. The multicast message was then sent to the Lunch Crew group. The message was received and then displayed on Peter's computer and Peter decided to respond to the group. To create his response, Peter selects the message 102 from RAD, for example, Peter may highlight or hover over the message using the cursor in the user interface 104. A popup or pull-down window 105a is then shown in the display 104 showing the highlighted message, and including a field 107a in which Peter can input his response. Peter types in his response “Can't make it—sick”, and then instructs the user interface to send the message to the group, for example, by clicking on the “Send” button.

FIG. 4B illustrates another example screen shot of an interface that may be used to display the multicast messages. Continuing with the example in FIG. 1, FIG. 4B illustrates an example display 104 on a different day than that of FIG. 1 and FIG. 4B for the user jg who asked if “Anyone wanted to hit the new Thai place for lunch today?” and indicating that he had to “leave at 12:30”. Instead of a scrolling window, this display 104 includes a messaging window 105b that list the messages from top to bottom and includes the text entry field 107b as part of the window 105b. User jg then uses the messaging window 105b to review messages from the group and to create his response message.

While FIGS. 4A and 4B illustrate various embodiments of messaging windows 105a, 105b and text entry fields 107a, 107b, it is recognized that a variety of configurations may be used to display the messages and allow users to create and send messages.

The Lunch Crew group examples above show that a user's message may be related to other group messages as well as to the group itself. However, the messages may be related to a different subject matter. For example, a user may send a message about a restaurant recommendation in a “Laker's Fan” group. As another example, Chris may find out that his grandmother is ill and then send a message with well wishes for his ill grandmother to his family group. Later, Chris may hear a song that he likes on a radio broadcast and provide a message to his family group recommending the song and artist and including a link for purchasing the song. Carla, who is also part of the family group, can then find and listen to the recommended song and provide her opinion of the song back to the family group. Chris may also send a similar message to his bluegrass music group. Thus, messages sent within a group do not need to be based directly on activity or content occurring within the group.

### III. Sample Operation

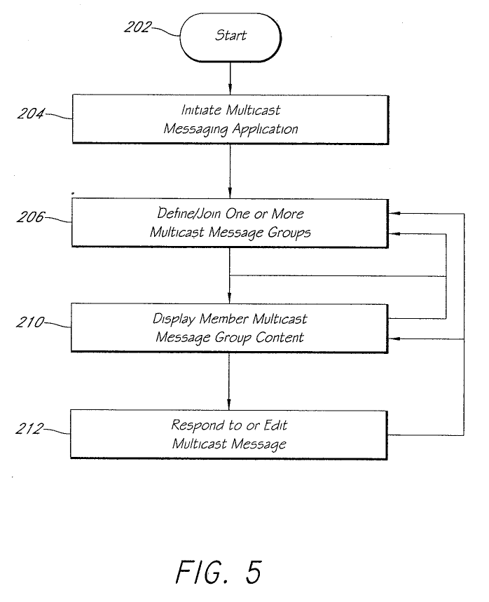

FIG. 5 is a high level flow chart of an embodiment of a method for a user using a messaging multicast system.

First, a user initiates a multicast messaging application (block 204) by selecting the multicast messaging application or the multicast messaging application may be automatically started without any action by the user. If the multicast messaging application is not already installed on the user's system, the user may download the multicast messaging application from the Internet or from a storage medium, such as a CD-ROM, USB device and so forth. The multicast messaging application may also require a subscription or enrollment with a multicast messaging service and may check the user's account status before allowing the user access to the multicast messaging application.

The user may then define and/or join one or more multicast messaging groups (block 206). For example, the user may create one or more new groups that may not yet exist within the system 100, such as a group of speakers of a foreign language within a given distance of his home. In addition, the user may join an existing group, such as a group of users who are interested in eco-friendly travel resorts. In some embodiments, the user's system may send to a server system the user's group definitions, information related to groups, and modifications to existing groups, where they are stored on the server system.

After the user is a member of one or more groups, the user may then receive messages associated with the user's groups. When a message is received by the user's system, it is then displayed and/or presented to the user (block 210). As set forth above, the message content may include text and may additionally or alternatively include hypertext links to and/or include online content, photo files, audio files, video files, executable files, or any other content that may be of interest to the group.

As the associated multicast messaging group content is displayed and/or presented to the user, the user may elect to respond or provide his input to one or more of his groups (block 212).

While various embodiments of FIG. 5 have been discussed above, it is recognized that other embodiments may be implemented.

### IV. Sample Methods

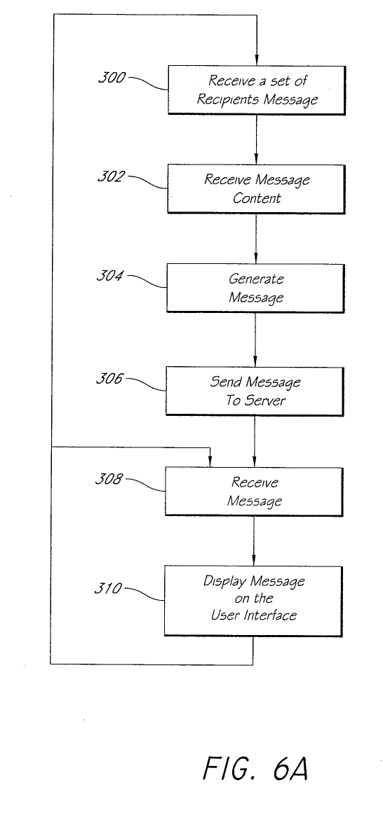

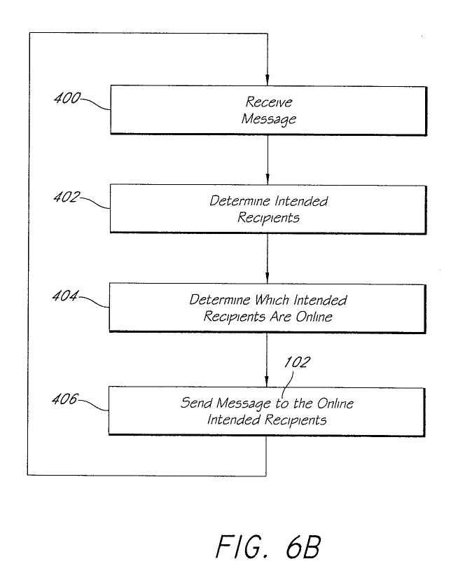

FIGS. 6A and 6B illustrate additional high-level flow chart of embodiments of processes implemented by the multicast messaging system 100. FIG. 6A illustrates embodiments of a process that may be implemented on a user system that is in communication with a server system. FIG. 6B illustrates embodiments of a process that may be implemented on a server system that is in communication with the user system.

A. User Process

Referring to FIG. 6A, the process begins by receiving a set of potential message recipients from the user (block 300). For example, the process may receive in indication designating one or more of his user groups as the recipient. The process also receives message content from the user, (block 302). The process then generates a message using the set of recipients and the content (block 304) and sends the message to the server system 504 (block 306).

The process may then receive a response message (block 308) from the server, and may display the content of the message on the interface (block 310). For example, if the content is text, the text may be displayed in a window, if the content is audio, the audio may be played and output via speakers on the user system, if the content is video, the video may be displayed in a video player on the user system, and so forth. In addition, the process may receive another message from the user (returning to block 308). The second message may be for the same group or for a different group.

The process allows the user to receive messages related to his groups. Thus, one user's set of received messages will be different from another user that is a member of a different set of groups. For example, a first user may be a member of a motorcycle riders group, a bluegrass music fans group, and a resident of Seattle, Wash. group. The first user may receive a first message about tune-up tips for a motorcycle that none of the other members of the bluegrass music fans group or the residents of Seattle, Wash. group receive. The first user may also receive a message about new aircraft orders received by the Boeing aircraft company that no other members of the motorcycle group or the bluegrass music fans group receive.

B. Server Process

Referring to FIG. 6B, the process begins by receiving a message from a user system (block 400). In one embodiment, the message includes message content as well as a set of one or more groups that are to receive the message. In other embodiments, the message and the intended group(s) are received separately. The process determines the set of intended recipients from the designated group(s) (block 402). The process then determines which of set of recipients are online (block 404). In some embodiments, the process operates in a substantially real time or “instant messaging” manner where content may not be archived or stored for users who are not currently available to receive content when the content is forwarded to the group. For example, in some embodiments content is only forwarded to the group of those users who are available to rapidly have the content provided to them, for example via their user interface. The process then forwards the message to the set of recipients in the group(s) who are online (block 406). In other embodiments, the process may send the message to all of the group members regardless of whether they are online. In some embodiments, the message includes instructions to the user system to display the message on the user system.

The process may also receive a response to the sent message from a user that is different from the user that sent the first message (block 400). The process may then determine which group(s) correspond(s) to the response message to determine the intended recipients of the message (block 402). For example, the response may include message content as well as an indication showing which group(s) received the message and/or which group members received the message. The process determines which users are online (block 404), and then forwards the response to the set of recipients (block 406).

The process may also receive a second message from the user that sent the first message (block 400). The second message may be a message responding to the response, a new message to the same group(s) as the first message, or it may be a message for a different one or more groups. In addition, the process may also receive a third message from another user that is not related to the first message, the response, or the second message. The third message may be for a different one or more groups.

C. Other Embodiments of the Processes

While various embodiments of FIGS. 6A and 6B have been discussed above, it is recognized that other embodiments may be implemented. In addition, it is recognized that all or part of the processes may run in parallel with other process allowing the user system and/or the server system to send and receive multiple messages from a single user and/or from multiple users.

### V. Multicast Messaging System

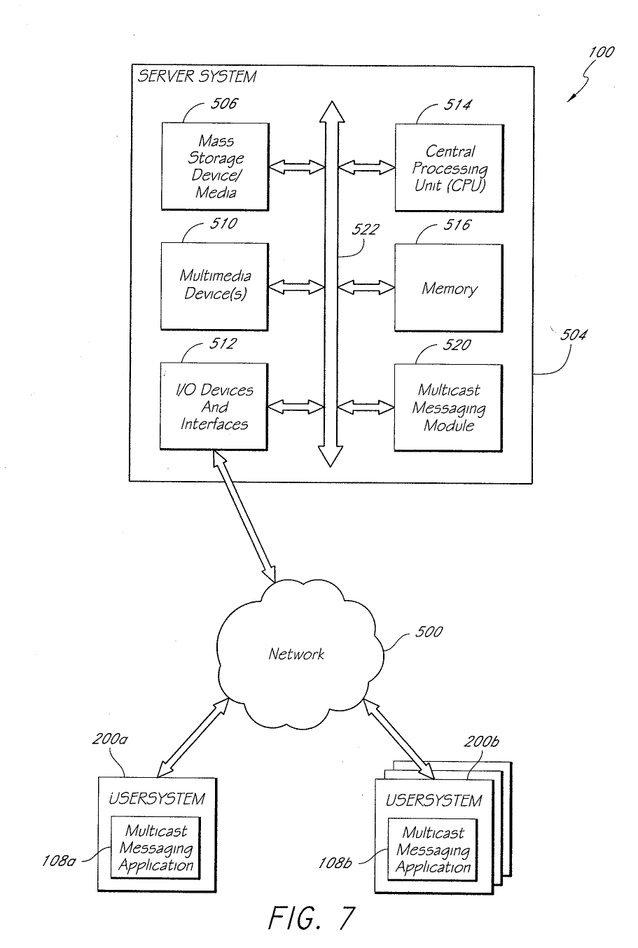

FIG. 7 is a high-level block diagram depicting one embodiment of a multicast messaging system 100. In the exemplary multicast messaging system 100, user systems 200 communicate with other user systems 200 and a server system 504 via a network 500. The exemplary user systems 200 operate a multicast messaging application module 106 which is configured to communicate with the server system 504 to send messages to and receive messages from other user systems 200 via the server system 504. In some embodiments, the multicast messaging system 100 operates at least partially in a client-server environment with hardware devices running application software.

A. Server System

The server system 504 receives multicast messages from user systems 200 and then forwards the messages to the appropriate user systems 200. In addition, the server system 504 manages and stores data on the groups of the multicast messaging system 100. The server system 504 is configured to run software for implementing one or more embodiments of the systems and methods for multicast communications described herein.

The server system 504 of FIG. 7 may be implemented on a computing device and includes a central processing unit (“CPU”) 514, a memory 516, and a mass storage device 506. The server system 504 also includes one or more commonly available input/output (“I/O”) devices and interfaces 512 that allow the visual presentation of data to a user, such as a system administrator and/or provide a communication interface to various external devices and systems, such as, for example, the network 500. The server system 504 also includes one or more multimedia devices 510.

The server system 504 also includes a Multicast IM Module 520 configured to receive messages from user systems, where the messages are designated for one or more groups. The Multicast IM Module 520 coordinates the forwarding of the message or content of the message to the members of the designated group(s). The Multicast IM Module 520 may also determine which of the members are online and then only forward the message or content of the message to online members of the designated group(s). The Multicast IM Module 520 may also maintain and update data related to the various groups, such as, for example, group definitions, membership criteria, group members, user information of the members of the groups, and so forth. The group data may be stored in the mass storage device 506 or in a local or remote database that is in communication with the Multicast IM Module 520. In addition, the Multicast IM Module 520 may implement the method of FIG. 7B.

While the server system 504 of FIG. 7 is illustrated as a single block, the server system 504 can be implemented as a single hardware assembly operating appropriate software or as a distributed network of a plurality of hardware devices operating appropriate software.

B. User System

The example user system 200a allows a user to communicate with other users systems 200b via the server system 504 using an instant messaging application. The instant messaging application may then allow the user to send instant messages to and receive instant messages from the user's group(s). In other embodiments, the user system 200 may use a separate application to implement multicast messaging.

The user systems 200 of FIG. 7 may be implemented on a computing device configured to communicate with the server system 504 and may include a Multicast Messaging Application 108. The user system 200 may include user interface programs with display capability and the ability for a user to provide control inputs. In some embodiments, the user systems 200 comprise keyboards and/or touchscreens to facilitate entry of text messages, a microphone to allow users to input audio signals, and/or a digital camera or video camera to allow a user to input images or video data. In some embodiments, the user system 200 also includes the ability to create and/or designate data files and/or executable files for forwarding to other users. In one embodiment, the Multicast Messaging Application 108 implements the method of FIG. 6A.

While the users systems 200 of FIG. 7 are illustrated as a single block, the user systems 200 may be implemented as a single hardware assembly operating appropriate software or as a distributed network of a plurality of hardware devices operating appropriate software. In addition, one or more of the user systems 200 may be implemented differently than other user systems 200.

C. Network

The network 500 may comprise one or more of a local area network, a wide area network, a landline, a cellular telephone network, the Internet, a wired network, wireless network and so forth. Moreover, the server system 100 may communicate with the user systems 200 using the same network 500 or different networks 500.

D. Computing Device

In one embodiment, the user systems 200 and the server system 504 run on one or more computing devices. In one embodiment, the computing devices are IBM, Macintosh, or Linux/Unix compatible devices. In another embodiment, the computing devices comprise a server, a laptop computer, a cell phone, a personal digital assistant, a Blackberry device, a kiosk, a mobile device, or an audio player, for example.

In one embodiment, the computing device includes one or more CPUs, which may each include microprocessors. The computing device may further include one or more memory devices, such as random access memory (RAM) for temporary storage of information and read only memory (ROM) for permanent storage of information, and one or more mass storage devices, such as hard drives, diskettes, or optical media storage devices. In one embodiment, the modules of the computing are in communication via a standards based bus system, such as bus systems using Peripheral Component Interconnect (PCI), Microchannel, SCSI, Industrial Standard Architecture (ISA) and Extended ISA (EISA) architectures, for example. In some embodiments, components of the computing device communicate via a network, such as a local area network that may be secured.

The computing device is generally controlled and coordinated by operating system software, such as the Windows 95, Windows 98, Windows NT, Windows 2000, Windows XP, Windows Vista, Linux, SunOS, Solaris, PalmOS, Blackberry OS, or other compatible operating systems. In Macintosh systems, the operating system may be any available operating system, such as MAC OS X. In other embodiments, the computing device may be controlled by a proprietary operating system. Conventional operating systems control and schedule computer processes for execution, perform memory management, provide file system, networking, and I/O services, and provide a user interface, such as a graphical user interface (GUI), among other things.

The computing device may include one or more commonly available input/output (I/O) devices and interfaces, such as a keyboard, mouse, touchpad, microphone, and printer. Thus, in one embodiment the computing device may be controlled using the keyboard and mouse input devices, while in another embodiment the user may provide voice commands to the computing device via a microphone. In one embodiment, the I/O devices and interfaces include one or more display devices, such as a monitor, that allows the visual presentation of data to a user. More particularly, a display device provides for the presentation of GUIs, application software data, and multimedia presentations, for example. The computing device may also include one or more multimedia devices, such as speakers, video cards, graphics accelerators, and microphones, for example. The computing devices may also include a communication interface to various external devices and the network 500 via wired or wireless communication links.

The computing devices may also store and run a variety of programs, such as, for example, a graphical user interface (“GUI”), application software, and so forth. The computing devices may also implement and/or communicate with one or more application modules that can include mail applications, printer interfaces, Internet or web browsers, media players, word processing applications, phone applications, and so forth.

E. Module

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules stored in memory and executed by a processing unit, but may be represented in hardware or firmware. Generally, the modules described herein refer to logical modules that may be combined with other modules or divided into sub-modules despite their physical organization or storage.

### VI. Additional Embodiments

Although the foregoing invention has been described in terms of certain embodiments, other embodiments will be apparent to those of ordinary skill in the art from the disclosure herein. Moreover, the described embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein. Thus, the present invention is not intended to be limited by the preferred embodiments. Furthermore, for purposes of discussing the invention, certain aspects, advantages and novel features of the invention have been described herein. Of course, it is to be understood that not necessarily all such aspects, advantages or features will be embodied in any particular embodiment of the invention.

What is claimed is:

1. A method of transmitting multicast messages, the method comprising:
receiving a first multicast instant message from a first sending user, the first multicast instant message indicating a first group;
identifying a first set of recipients related to the first group; and
transmitting the first multicast instant message to the first set of recipients.

2. The method of claim 1, wherein transmitting the first multicast instant message to the first set of recipients includes transmitting the first multicast instant message to the first sending user.

3. The method of claim 1, wherein identifying a first set of recipients related to the first group further includes:
determining which of identified first set of recipients are online.

4. The method of claim 3, wherein transmitting the first multicast instant message to the first set of recipients comprises transmitting the first multicast instant message to the identified first set of recipients that are online.

5. The method of claim 1, further comprising:
for at least one of the identified first set of recipients, sending an instruction to display the first message for the at least one of the identified online recipients via a recipient user interface.

6. The method of claim 5, wherein the message is displayed for the at least one of the indentified first set of recipients in a window on a display of the recipient user interface.

7. The method of claim 1, further comprising:
receiving a second multicast message from a second sending user, the second multicast message indicating a second multicast message group;
identifying a second set of recipients related to the second message group;
transmitting the second message to the identified recipients in the second set of recipients.

8. The method of claim 7, wherein at least one of the recipients in the second set of recipients is the same as at least one of the recipients in the first set of recipients.

9. The method of claim 7, wherein at least one of the recipients in the second set of potential recipients is not the same as at least one of the recipients in the first set of recipients.

10. The method of claim 1, further comprising:
removing any member of the first set of potential recipients where there is not double linking between the first sending user and that member of the first set of potential recipients.

11. The method of claim 1, further comprising:
receiving a definition of a group from a user system.

12. The method of claim 1, further comprising:
dynamically updating the message groups based on user input.

13. A computer-readable medium having stored thereon executable instructions that, when executed by a processor, cause the processor to perform the method of claim 1.

14. A multicast messaging system, comprising:
a computer system having a processor that supports operation of a software application;
a data storage module, including a plurality of group data, in communication with the computer system; and
a multicast message module configured to:
receive a first multicast message from a first sending user, the first multicast message indicating a first multicast message group;
identify a first set of recipients related to the first message group using the plurality of group data; and
transmit the first message to the identified recipients; and
wherein the computer system is capable of receiving a multicast message and communicating the multicast message to the multicast message module.

15. The multicast messaging system of claim 14, wherein the a multicast message module is further configured to determine which of identified first set of recipients are online and to transmit the first multicast instant message only to the identified first set of recipients that are online.

16. The multicast messaging system of claim 14, wherein the multicast message module is further configured to receive user input and to modify multicast message groups based at least in part on the user input.

17. The multicast messaging system of claim 14, wherein the multicast message module is further configured to:
receive a second multicast message from a second sending user, the second multicast message indicating a second multicast message group;
identify a second set of recipients related to the second message group; and
transmit the second message to the identified recipients in the second set of potential recipients.

18. A computer readable storage media comprising:
instructions to cause a first computer access data related to a plurality of multicast message groups;
instructions to cause the first computer to receive a first multicast message from a first sending user, the first multicast message indicating a first of the multicast message group;
instructions to cause the first computer to identify a first set of active recipients who are members of the first message group and are actively in communication with the first computer; and
instructions to cause the first computer to transmit the first message to the first set of active recipients.

19. The first computer readable storage media of claim 18, further comprising instructions to induce the first computer to modify the plurality of multicast message groups upon receipt of input from one or more of the users.
